(19) United States
(12) Patent Application Publication
(10) Pub. No.: US 2003/0028503 A1
(43) Pub. Date: Feb. 6, 2003

(54) Method and apparatus for automatically extracting metadata from electronic documents using spatial rules

(76) Inventors: Giovanni Giuffrida, Los Angeles, CA (US); Eddie Shek, Sherman Oaks, CA (US); Jihoon Yang, Fairfax, VA (US)

Correspondence Address: Tope-McKay & Associates, 23852 Pacific Coast Highway #311, Malibu, CA, 90265, US

(21) Appl. No.: 09/835,064

(22) Filed: Apr. 13, 2001

(51) Int. Cl. G06F 7/00

(52) U.S. Cl. 707/1

(57) ABSTRACT

A spatial knowledge base approach for the automatic extraction of metadata 116 from electronic documents 100. The electronic document 100 is converted to a substantially format invariant data file 104 by an intermediate language conversion element 102. Spatial layout facts 108 are extracted and combined with spatial layout rules 114 from a knowledge engineer 112 in a spatial metadata-reasoning element 110 to provide the metadata 116. The invention is based on mimicking the visual and spatial knowledge that humans make use of when reading a document.

### TECHNICAL FIELD

The present invention relates generally to the extraction of metadata from electronic documents. More specifically, this invention relates to a combination of text based matching and spatial reasoning used in the extraction of metadata.

### BACKGROUND

Digital libraries have been introduced to the Internet and are utilized to store a variety of documents and provide retrieval services for the documents. Documents in digital libraries include journal articles, conference papers, technical reports, and dissertations. Most digital libraries retrieve relevant documents utilizing a keyword-based search in human-generated database indices. Some systems automatically generate citation indices from a document, providing a framework for literature retrieval by following citation links. Evaluation of the document is based on the number of citations, and identification of research trends. The above-described system locates, downloads, and parses certain electronic files to extract citations from the documents in order to produce the citation index. However, this system does not extract other useful information from the document such as title, author, and affiliations.

A fundamental step in automatically introducing electronic documents into a digital library system is to disaggregate each document into its basic constituents, so a reader can effectively index, search, and disseminate the document. For example, in a scientific paper, metadata such as authors, affiliations, title, abstract, and citations play a fundamental role in consolidating the knowledge of the reader. Therefore, it is important to extract such metadata in an efficient and accurate manner.

In the past, various systems have been presented to disaggregate text-based documents. They generally fall into one of the following two general categories. The first category is, context-free grammar parsing. When utilizing such system a somewhat rigid syntactical structure of the document is necessary. The text is composed of set tokens and a set of syntactical rules to express legal relationships among the tokens. This is the de-facto approach for computer language interpreters and compilers. This approach requires a well-defined syntax and it is generally too rigid to parse free text.

The second category uses domain semantics based parsing. In this approach a parser that embeds specific domain knowledge is used. Such a parser recognizes keywords and structural relationships for a well-defined domain of the document being considered. The parser is highly trained to work on a specific domain and its application to another domain requires significant changes to the parser itself.

Based on the above-described shortcomings, there is a need for a system that is able to automatically extract a full range of metadata from electronic documents, using a combination of text-based matching and spatial reasoning that better matches human behavior.

### SUMMARY OF THE INVENTION

The present invention overcomes the deficiencies of currently available systems by using a combination of text-based matching and spatial reasoning that better matches human behavior to automatically extract a full range of metadata from electronic documents.

In one embodiment of the present invention a first processing element is configured to convert electronic documents into substantially format-invariant data files. The first processing element provides the substantially format-invariant data files to a second processing element. The second processing element is configured to receive substantially format-invariant data files, extract spatial layout facts, and provide the extracted spatial layout facts to a reasoning element. A database is configured to simultaneously provide spatial layout rules to the reasoning element; the spatial layout rules are used to extract the metadata from the substantially format-invariant data file.

Another embodiment of the present invention provides a method for automatically extracting metadata from electronic documents utilizing a first processing element and a second processing element, a reasoning element, and a database. The method includes the steps of using said first processing element to convert electronic documents to files, and using the first processing element to provide the files to the second processing element. The second processing element is utilized to receive said files and extract predetermined information. Further, the second processing element is utilized to provide extracted, predetermined information, to the reasoning element. Next, using the database, the method provides input to the reasoning element. Using a set of rules, the reasoning element extracts metadata from the files. This extracted meta-data is provided as an output of metadata from the reasoning element.

### BRIEF DESCRIPTION OF DRAWINGS

The accompanying drawings, which are incorporated in, and form a part of the specification, illustrate embodiments of the invention and, together with the description, serve to explain the principles of the invention.

FIG. 1 is a flowchart showing the overall architecture of one embodiment of the present invention;

FIG. 2 is a depiction of the upper portion of a scientific paper; and

FIG. 3 is a depiction of the upper portion of a scientific paper illustrating that the title is not always the first string of text on a page.

### DETAILED DESCRIPTION

The present invention provides a method and apparatus for the extraction of metadata from electronic documents. It should be understood that this description is not intended to limit the invention. On the contrary, the invention is intended to cover alternatives, modifications and equivalents, which are included in the spirit and scope of the invention as defined by the appended claims. Furthermore, in the following detailed description of the present invention numerous specific details are set forth in order to provide a thorough understanding of the present invention. However, it will be obvious to one of ordinary skill in the art that the present invention may be practiced without the specific details.

One embodiment of the present invention provides a spatial knowledge-based methodology to document disaggregation. This approach can be easily configured to achieve improved document metadata extraction accuracy. The present embodiment is based on exploiting the visual and spatial knowledge used when reading a document. In general, within a document category, a certain visual layout can be identified for all documents within that category. For instance, a scientific paper may follow the format described below. Wherein the uppercase words represent metadata in the paper and bold words denote spatial relationships and other types of relationships.

The TITLE is located on the upper portion of the first page and it is printed using the largest font on the first page;

AUTHORS are listed immediately under the TITLE in some order;

AFFILIATIONS follow the authors' list;

If only one AFFILIATION appears then all AUTHORS are associated with it;

The same font is used for all AUTHORS and, similarly, for all AFFILIATIONS;

The FIRST LEVEL HEADERS use a larger font than the SECOND LEVEL headers.

In the present invention, a rule-based language is used to encode the visual layout of the document. Different types of documents require different knowledge bases. A knowledge base is encoded with visual and spatial layout facts. The knowledge base described in this embodiment deals with scientific papers appearing in conference proceedings and specialized journals. The apparatus configured to perform the steps could include a standard personal computer or other apparatus having the adequate processing power.

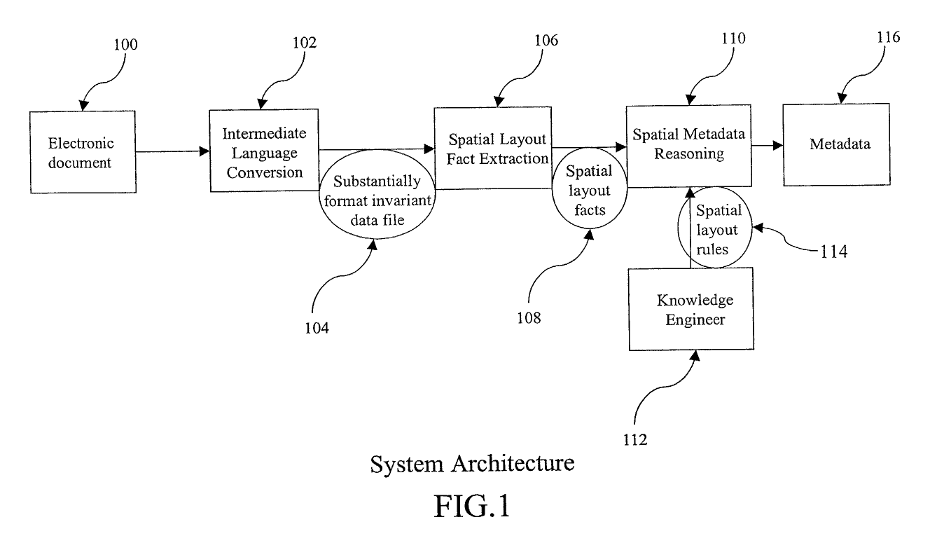

In FIG. 1 the overall architecture of the metadata extraction system is shown. The metadata extraction system retains the document's original formatting. Formatting includes both font size and text positioning on the page. Hereinafter, data that retains the original document's formatting shall be referred to as substantially format-invariant data.

Electronic documents 100 go to an intermediate language conversion step 102, which is responsible for converting the electronic documents 100 into substantially format-invariant data files 104, and capturing the spatial and visual aspects for document representation. This can generally be achieved by transferring the original document to a file from the default viewer of the document. A converted document has to undergo a spatial layout fact extraction process 106 to extract relevant spatial layout information and eliminate irrelevant information from the converted document in preparation for further processing. This is a task generally accomplished by any substantially format-invariant data printer driver or viewer.

One embodiment of the present invention uses a rule-based language to encode spatial facts in documents as well as rules that interpret these facts to extract metadata from them. The rule based language output consists of a set of augmented strings of text. This additional format data is summarized in the following:

1) Page of the document where the specific string appears;

2) Absolute line counter order for each generated string;

3) x-y location of the lower left corner of the string bounding box in paper-dot coordinate systems;

4) x-y location of the upper right comer of the string bounding box in paper-dot coordinate systems;

5) Font metrics bounding-box extensions used to represent the given string of text.

After spatial layout facts 108 have been extracted 106 from a substantially format-invariant data file 104, spatial layout facts 108 are subjected to spatial metadata reasoning 110. A knowledge engineer 112 provides a set of spatial layout rules 114 that embodies the protocol for extracting the metadata 116 of interest from the provided document. A rule-based language reads the provided format-invariant data file and produces a set of spatial layout facts 108 for the rule-based language. Each fact contains information—text and spatial data—about the input substantially format-invariant data document. Rules provided by the knowledge engineer 112 reasons with the extracted facts to identify and extract relevant metadata 116 from the input documents.

The knowledge base of the present invention reasons with the spatial layout facts extracted from the substantially format-invariant data to rule-based language. The knowledge base is encoded by means of the rules of the rule-based language. The rule set is designed to extract information from the substantially format-invariant data file such as: title, author(s), affiliation(s), mapping(s), author-affiliation, and table of contents. In this embodiment of the invention the knowledge base is comprised of 77 rules. The following shows the rule based language rule usage distribution for the different extraction purposes:

| Extraction Purpose | Number of rules involved |
|---|---|
| Title | 9 |
| Author(s) | 12 |
| Affiliation(s) | 10 |
| Author Affiliation | 10 |
| Table of Contents | 8 |
| Print results | 19 |
| Other | 9 |

A fundamental component of the knowledge base is the implicit fuzziness involved in the visual and spatial based metadata recognition process. For instance, with reference to the list of spatial layout fact extraction activities earlier discussed, note that:

a. The title is not always printed on the first page using the largest font.

b. Not all papers use numbered section headers and section headers do not always use different fonts.

c. Sometimes authors are all listed on the same line next to each other while other times the author's names are scattered across different lines.

When authors have different affiliations, different methods are employed to specify their correspondence. Two of the most popular methods are:

i. Superscripting on author's name corresponding to the author's affiliation; and

ii. Determining the spatial proximity of the author's name to the author's affiliation.

Many different cases exist such as reporting affiliations as footnotes or listing authors vertically with prospective affiliations to the right on the same line. These exceptions represent the hardest part of the artificial visual recognition process. The rule-based language is coded in the knowledge base in order to be tolerant of such exceptions.

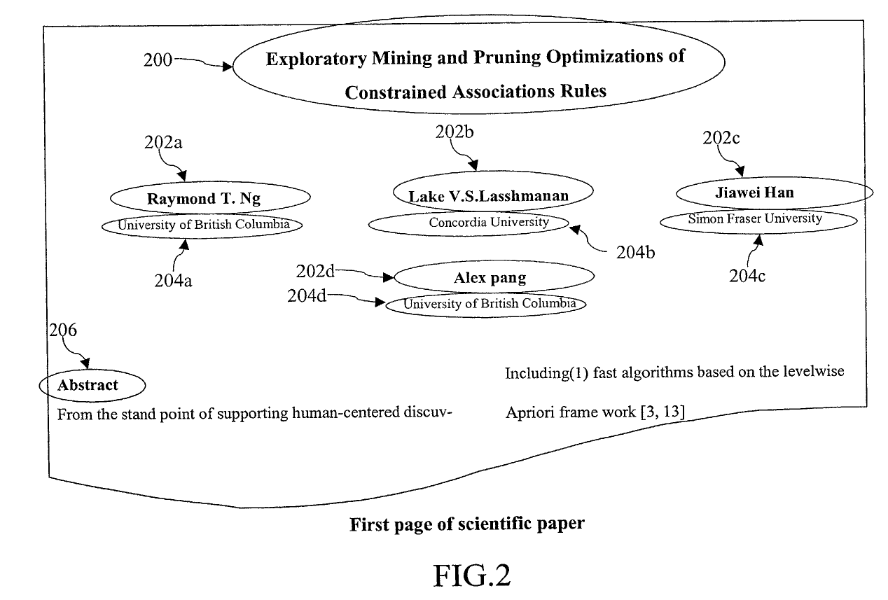

The following is an example of how the present invention extracts metadata from electronic documents. Consider the portion of a scientific paper as shown in FIG. 2. Once the substantially format-invariant data to rule based language has extracted all necessary facts from the substantially format-invariant data file, the facts are processed using a rule-based language. The output of the rule based language screen for the document in FIG. 2 is as follows:

FILE: sigmod98

TITLE: Exploratory Mining and Pruning Optimization of Constrained

Association Rules

AUTHOR: Raymond T. Ng (1)

AUTHOR: Laks V. S. Lasshmanan (2)

AUTHOR: Jiawei Han (3)

AUTHOR: Alex Pang (1)

AFFILIATIONS 1: University of British Columbia

AFFILIATIONS 2: Concordia University

AFFILIATIONS 3: Simon Fraser University

### Table of Contents

1 Introduction

3 Constrained Association Queries

4 Optimization Using Anti-Monotone

5 Optimization Using Succinct

6 Algorithms for Computing

6.1 Algorithms Apriori +

6.2 Algorithms Hybird (m)

6.3 Algorithms CAP

7 Conclusions and Future Work

The title 200 has been assembled from two lines into a single line. The first author 202a, the second author 202b, the third author 202c, and the fourth author 202d have been correctly identified and linked to the first affiliation 204a, the second affiliation 204b, the third affiliation 204c, and the fourth affiliation 204d respectively. Notice that the system reports the first affiliation 204a and the second affiliation 204b “University of British Columbia” only once even though it is associated with the first author 202a and the fourth author 202d.

If the title 200 of a scientific document is contained in the first line of the text, or the first couple of lines of text for longer titles, a text based extraction from a substantially format-invariant data file 104 could be applied. The output data can either be displayed using a user interface, sent to a storage medium, or printed.

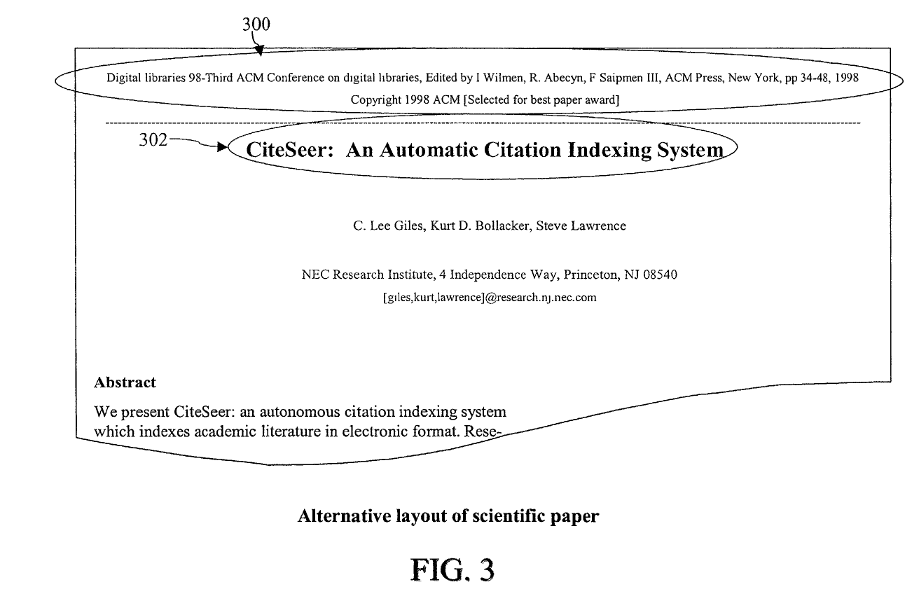

There are cases, as illustrated in FIG. 3 where the title is not the first string of text on the page. When information regarding the proceedings 300 of the document is above the title 302, a straight text based approach will not be efficient in extracting the desired information.

The following rule based language was encoded with the following two hints in the knowledge base when extracting titles. Titles appear on the first page of the document and very often are printed using the largest font on the first page. Sometimes section headers use a larger, or same size, font than the title. In such a case the word “Abstract” 206 is relied on. The lines printed above “Abstract” 206 are extracted, and by using the largest font among all the lines above that word, the title can be found. The following rule based language rules are used to extract the title 200 from the paper when the word “Abstract” 206 was found on the first page as a stand-alone string:

(defrule CandidateTitleLines

(declare (salience 9100) )
(abstract-word-found ?1a)
(doc (page 1) (font ?f $?)

(absline ?n&: (< ?n ?1a) ) (text ?s) )

(metrics (page 1) (font ?f) (bbh ?h1) )
=>
(assert (candidate-title-line ?n ?h1 ?f ?s) ) )

(defrule GetLargestFontForCandidateTitle

(declare (salience 9090) )
(abstract-word-found ?1a)
(candidate-title-line ?n ?h1 ?f ?)
(not (candidate-title-line ?

?h2&: (> ?h2 ?h1)
? ? ) )

=>
(assert (1tf ?f) ) )

(defrule GetTitle1

(declare (salience 9000) )
(abstract-word-found ?1a)
(1tf ?f)
(candinate-title-line ?n ?h1 ?f ?s)
(not (candidate-title-line

?n2&: (< ?h2 ?h1)
? ?) )

=>
(assert (paper-title ?n ?s)))

(defrule GetTitleNextLines

(declare (salience 9000) )
(abstract-word-found ?1a)
(1tf ?f)
(candidate-title-line ? ?h1 ?f ?s)
(not (candidate-title-line ?n2&: (< ?n2 ?n)

? ?f ?))

=>
(assert (paper-title ?n ?s)))

(defrule GetTitleNextLines

(declare (salience 9000))
(abstract-word-found ?1a)
(1tf ?f)
?indx <−(paper-title ?n ?s)
(candidate-title-line ?n2&: (= (+ 1 ?n) ?n2)

? ?f ?t)

=>
(retract ?indx)
(bind ?s (str-cat ?s ““ ?t) )
(assert (paper-title ?n2 ?s) ) )

The first rule is CandidateTitleLines, the second rule is GetLargestFontForCandidateTitle and the third rule is GetTitleNextLines. The first rule, CandidateTitleLines, considers all lines above the line containing the word Abstract 208 as candidates for the title 200. These lines include the first author 202a, the second author 202b, the third author 202c, and the fourth author 202d, and the first affiliation 204a, the second affiliation 204b, the third affiliation 204c, and the fourth affiliation 204d. At the same time the first rule, CandidateTitleLines, extracts the font size of each text line and stores the data. In a subsequent step the rule GetLargestFontForCandidateTitle extracts the largest font from among all candidate title lines. The rule GetTitle1 gets the first line of the title 200. The title is identified as the line having the largest font and not having any other line above it having the same size font. The last rule, GetTitleNextLines, searches for multi-line titles and merges successive title lines having the same font type and size.

When authors' 202 names are printed using the same font as the title 200 and both titles and authors' 202 names appear above the abstract, 206, the knowledge base may have to be further reinforced by relying on the line-position, measured along the y-coordinate. In spatial based mapping of the first author 202a, the second author 202b, the third author 202c, and the fourth author 202d, to the first affiliation 204a, the second affiliation 204b, the third affiliation 204c, and the fourth affiliation 204d, a rule first extracts the relevant information and then attempts to match the authors with their respective affiliations 204. There are many different cases to be considered since there is not necessarily a one-to-one correlation between the authors 202 and affiliations 204. In the simplest case, there are n authors 202 all matched to one affiliation 204; a single rule based language takes care this type of matching. Another case arises when the number of authors 202 differs from the number of affiliations 204 and there is more than one affiliation. In such a case a common practice, utilized by most publishers, is to use superscripts over author's 202 names and affiliations 204. A text-based parsing protocol is exploited to resolve the associations in this case. The case now discussed is the n-to-n mapping as shown in FIG. 2. Notice that one affiliation appears twice. The first affiliation 204a and the second affiliation 204b. In this case a spatial reasoning is operation is performed. The operation links each author 202 to that author's affiliations 204. This is accomplished by following the rules of the rule-based language:

(defrule XY-AffiliationLocation

(declare (salience 5800) )
(paper-affiliations ?n ?t)
(doc (page 1) (absline ?n) (xc ?xc) (y?y) )
=>
(assert (xy-AFFILIATION ?n ?xc ?y) ) )

(defrule XY-AuthorLocation

(declare (salience 5800) )
(paper-authors ?n ?t)
(doc (page 1) (absline ?n) (xc ?xc) (y ?y) )
=>
(assert (xy-author ?n ?xc ?v) ) )

(defrule SpatialLink-1

Declare (salience 5800) )
(xy-author ?n ?xp ?yp)
(xy-affiliation ?m ?xa ?ya)
=>
(assert (link-distance ?n ?m

=(sqrt (+ (* (− ?ap >xa) (−?xp ?xa) )
(* (− ?yp ?ya) (−?yp ?ya ) ) ) ) ) ) )

(defrule SpatialLink-2

(declare (salience 5800) )
(n-affiliations ?n ?)
(paper-authors ?na ?t)
(not (link ?t ? ) )
(link-distance ?na ?m ?d1)
(paper-affiliations ?m ?tt)
(not (link-distance ?na ? ?d2&: (< ?d2 ?d1) ) )
=>
(assert (link ?t ?tt ) ) )

The rule XY-AffiliationLocation confirms the xy location, in paper dot coordinates, of the center of the string bounding box of each affiliation, i.e. the slot xc of the fact doc, which contains that location. Similarly, the rule XY-AuthorLocation confirms the bounding box center xy location of each author. In turn, the rule SpatialLink-1 computes the Euclidean distance among each possible pair author-affiliation and confirms all possible combinations using the fact link-distance. Eventually a rule, SpatialLink-2, associates each author to the spatially closest affiliation and confirms this by using the fact link.

When extracting table of contents, two basic cases are distinguished: numbered section headers and non-numbered section headers. Different sets of rules are used according to the style adopted by the paper at hand. Thus, the first thing the rule base does is determine if the section headers are numbered. Section header numbering is a fundamental hint for a text-based extraction of table of contents. This is because the numbering is expected to follow a certain order throughout the paper and the numbers virtually always appear at the beginning of the line. However, headers are often not numbered, therefore an extraction based on text parsing is not applicable. In the rule based system the visual properties of section headers are exploited. The section headers have a larger font than the text before and after and also have a different line-space compared to the average line-space of the entire document. Furthermore, a common header name such as “Introduction,” “Overview,” “Motivation,” or “References” is sought in an effort to find an initial clue for the font size of the first level of headers.

Another embodiment of the present invention includes an apparatus for automatically extracting metadata from electronic documents. The apparatus may be an apparatus such as a conventional computer or other data processor. The apparatus includes a first processing element, a second processing element, a reasoning element, and access to a database. The database may be non-local and accessed via a network, or it may be local. The first processing element is further configured to convert electronic documents into files. The first processing element is configured to provide the files to a second processing element and the second processing element is configured to extract predetermined information from the provided file. The second processing element is further configured to provide the extracted predetermined information to the reasoning element. The database is configured to also provide input to said reasoning element. The reasoning element is configured to use a set of rules to extract metadata from the files and the reasoning element provides an output of metadata. This output can go either to a printer, storage medium, or display.

What is claimed is:

1. An apparatus for automatically extracting metadata from electronic documents comprising a first processing element, a second processing element, a reasoning element, and a database, wherein,
i) said first processing element is further configured to convert electronic documents into files;
ii) said first processing element is configured to provide the files to a second processing element;
iii) said second processing element is configured to receive said files and extract predetermined information;
iv) said second processing element is further configured to provide said extracted predetermined information to said reasoning element;
v) said database is configured to also provide input to said reasoning element;
vi) said reasoning element is configured to use a set of rules to extract metadata from the files; and
vii) said reasoning element provides an output of metadata.

2. An apparatus for automatically extracting metadata from electronic documents as set forth in claim 1, wherein said files are substantially format invariant data files such as Postscript files

3. An apparatus for automatically extracting metadata from electronic documents as set forth in claim 1, wherein said predetermined information is substantially spatial layout facts.

4. An apparatus for automatically extracting metadata from electronic documents as set forth in claim 1, wherein the second processing element and said database simultaneously input to the reasoning element.

5. An apparatus for automatically extracting metadata from electronic documents as set forth in claim 1, wherein said set of rules can be updated.

6. An apparatus for automatically extracting metadata from electronic documents as set forth in claim 1, wherein said metadata is substantially comprised of title, author, affiliation, author affiliation, and table of contents.

7. An apparatus for automatically extracting metadata from electronic documents as set forth in claim 1, wherein said metadata is provided to a user interface.

8. An apparatus for automatically extracting metadata from electronic documents as set forth in claim 1, wherein said metadata is provided to a storage medium.

9. A method for automatically extracting metadata from electronic documents providing a first processing element, a second processing element, a reasoning element, and a database and comprising the steps of:
a) using said first processing element to convert electronic documents to files;
b) further using said first processing element to provide the files to said second processing element;
c) using said second processing element to receive said files and extract predetermined information;
d) further using said second processing element to provide extracted predetermined information to said reasoning element;
e) using said database to provide input to said reasoning element;
f) using a set of rules in said reasoning element to extract metadata from the files;
g) providing an out put of metadata from said reasoning element.

10. The method for automatically extracting metadata from electronic documents as set forth in claim 9, wherein said files are substantially format invariant data files such as Postscript files.

11. A method for automatically extracting metadata from electronic documents as set forth in claim 9, wherein said predetermined information is substantially spatial layout facts.

12. A method for automatically extracting metadata from electronic documents as set forth in claim 9, wherein the second processing element and the database simultaneously input to the reasoning element.

13. A method for automatically extracting metadata from electronic documents as set forth in claim 9, wherein said set of rules can be updated.

14. A method for automatically extracting metadata from electronic documents as set forth in claim 9, wherein said metadata is substantially comprised of title, author, affiliation, author affiliation, and table of contents.

15. A method for automatically extracting metadata from electronic documents as set forth in claim 9, wherein said metadata is provided to a user interface.

16. A method for automatically extracting metadata from electronic documents as set forth in claim 9, wherein said metadata is provided to a storage medium.
